(19) United States
(12) Patent Application Publication
(10) Pub. No.: US 2019/0378139 A1
(43) Pub. Date: Dec. 12, 2019

(54) TRACKING AND RECOVERING TRANSACTIONS PERFORMED ACROSS MULTIPLE APPLICATIONS

(71) Applicant: The Bank of New York Mellon, New York, NY (US)

(72) Inventors: Sanjaykumar Stribady, Monmouth Junction, NJ (US); Saket Sharma, Edison, NJ (US); Gursel Taskale, Manhasset, NY (US)

(21) Appl. No.: 16/001,772

(22) Filed: Jun. 6, 2018

(51) Int. Cl. G06Q 20/40; H04L 9/06; G06F 17/30; H04L 29/08; G06F 9/46

(52) U.S. Cl. CPC G06Q 20/407; H04L 9/0637; G06F 9/466; H04L 67/1042; H04L 67/125; G06F 17/30424

(57) ABSTRACT

As steps of transactions are performed, a tracking system tracks the transactions by writing blocks of reports representing the performed steps of the transactions into a master blockchain. The master blockchain serves as an immutable record of performed steps for all transactions. The tracking system further generates individual lineage blockchains that include blocks of reports that are specific for a particular transaction, and the order of their creation. Therefore, each lineage blockchain serves as immutable record of performed steps for a specific transaction. The tracking system can monitor the states of the transactions as they are performed by accessing individual lineage blockchains. Therefore, when a transaction exception (e.g., a transaction error) occurs for a transaction, the tracking system can identify the transaction that is affected and can initiate a recovery process to ensure that the transaction exception is rectified.

### TECHNICAL FIELD

Embodiments of the invention generally relate to processing transactions using a computer system having multiple applications, and more specifically to tracking and recovering transactions using blockchains.

### BACKGROUND

Transactions are often processed by computing systems across multiple applications. For example, to fulfill a transaction, a first application may perform steps to initiate the transaction, a second application may perform steps to obtain approval for the transaction, and a third system may perform steps to report the transaction. Transactions may be fulfilled and completed, though in some circumstances, transaction errors may occur. Transaction errors may arise due to naïve issues (e.g., an application fails) or due to malicious actors (e.g., fraud or hacking). Therefore, identifying transactions that have been affected by transaction errors is important for ensuring that transactions are appropriately completed.

As the number of transactions scales upward, the execution of transactions across the multiple applications becomes complex. If a transaction error occurs, conventional applications are not equipped to identify, amongst the numerous transactions, which particular transaction is affected and to what extent the parties involved are affected. Therefore, a transaction error can be problematic as significant resources, such as time and human effort, may need to be dedicated to identify the particular transaction and to trace and rectify the transaction error.

### SUMMARY

A tracking system monitors transactions as the transactions are performed across different transaction processing applications. The tracking system receives reports that indicate the steps of each transaction that have been successfully performed. The tracking system writes blocks of the reports into a first blockchain, hereafter referred to as a master blockchain. Maintenance of the master blockchain ensures that the tracking system maintains an immutable record of all steps that have been performed for the various transactions. The tracking system further generates blocks of reports in additional blockchains, hereafter referred to as lineage blockchains. Each lineage blockchain includes an immutable record of reports that correspond to the steps of a specific transaction. In other words, each lineage blockchain includes a subset of the reports that are included in the master blockchain, re-ordered into a sequence of reports corresponding to the steps of the particular transaction. In various embodiments, the lineage blockchains can be generated from the reports included in the master blockchain. Thus, as a lineage blockchain can be generated from the master blockchain, a lineage blockchain specific for a transaction can be discarded from memory when no longer needed (e.g., once the transaction completes).

The tracking system periodically determines the state of each transaction, which represents a current stage of the transaction after the most recently performed step of the transaction, by accessing the blocks of reports of the lineage blockchains. If a transaction is not in an expected state, the tracking system determines that a transaction exception (e.g., a transaction error) has occurred for the transaction. The tracking system can determine whether the transaction has been inappropriately altered by comparing the immutable data of the blocks in the lineage blockchain against the datastream reported from the transaction experiencing an exception. Once the exception has been identified, the tracking system can address the transaction exception by initiating a recovery process such that the remaining steps in the transaction are performed.

The benefits of embodiments of the invention described herein are several-fold. First, conventional systems often handle large volumes of transactions at any given time but do not have an ability to track the current state of a transaction as it is being performed. For example, many conventional systems may implement a ledger that merely tracks a running balance as transactions are executed. Here, the tracking system enables the tracking of transactions at a high level of specificity. Specifically, the tracking system can monitor individual steps of the transaction as they are performed, noting their order and their completion state. Monitoring the performed steps of a transaction enables the identification of transaction exceptions that may occur when handling large volumes of transactions. Additionally, by monitoring the individual steps of transactions, the tracking system can identify transaction errors as they are developing in real-time. For example, the tracking system can identify that a threshold number of transactions have stalled. Therefore, the tracking system can take appropriate remedial action to ensure that the transaction errors corresponding to the transactions do not develop into more severe and widespread problems.

Second, implementing the master blockchain and individual lineage blockchains leverages the immutability of blockchain technology. This enables the detection of unauthorized changes that may arise due to malicious activity and/or transaction errors at particular steps of a transaction.

Third, lineage blockchains can be generated from the persistently stored master blockchain and therefore, lineage blockchains can be discarded from memory when they are no longer needed (e.g., when transactions are completed). Not having to persistently store lineage blockchains reduces the quantity of computational resources (e.g., computer memory) that are consumed to maintain the blockchains.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 depicts an overall system environment for tracking and recovering transactions, in accordance with an embodiment.

FIG. 2A depicts an example block diagram of a report system, in accordance with an embodiment.

FIG. 2B depicts an example block diagram of a tracking system, in accordance with an embodiment.

FIG. 3 depicts an example master blockchain that includes blocks of reports, in accordance with an embodiment.

FIG. 4 depicts an example lineage blockchain that includes blocks of reports that are specific for a transaction, in accordance with an embodiment.

FIG. 5A depicts a flow process for generating reports of performed steps of transactions, in accordance with an embodiment.

FIG. 5B depicts a flow process for managing states of transactions using immutable lineages, in accordance with an embodiment.

FIG. 6 is a high-level block diagram illustrating physical components of a computer, in accordance with an embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. For example, a letter after a reference numeral, such as “transaction processing application 110A,” indicates that the text refers specifically to the element having that particular reference numeral. A reference numeral in the text without a following letter, such as “transaction processing application 110,” refers to any or all of the elements in the figures bearing that reference numeral (e.g. “transaction processing application 110” in the text refers to reference numerals “transaction processing application 110A” and/or “transaction processing application 110B” in the figures).

### Overall System Environment

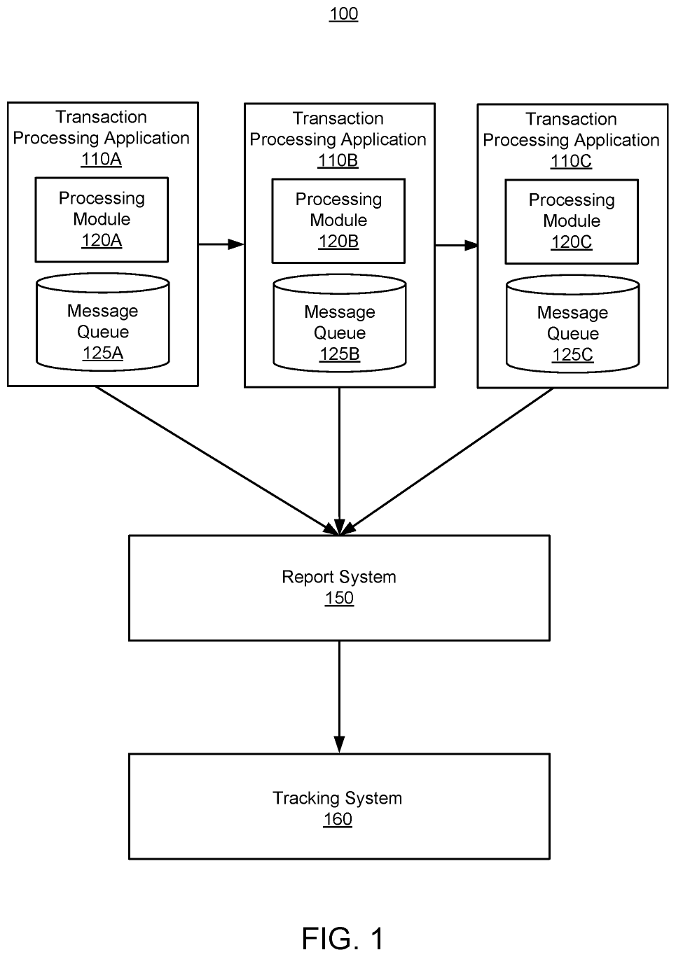

FIG. 1 depicts an overall system environment 100 for tracking and recovering transactions, in accordance with an embodiment. The system environment 100 can include one or more transaction processing applications 110, a report system 150, and a tracking system 160. Generally, the report system 150 and the tracking system 160 included in the system environment 100 enable the tracking of transactions as they are being processed by the transaction processing applications 110. By tracking the transactions, when a transaction exception occurs, the affected transaction can be rapidly identified, recovered, and executed as intended.

Although FIG. 1 depicts three transaction processing applications 110, in other embodiments, there may be fewer or additional transaction processing applications 110. Additionally, although FIG. 1 depicts a report system 150 that is separate from the tracking system 160, in various embodiments, the report system 150 and the tracking system 160 can each be associated with an entity and can be operated by that same entity. In some embodiments, the report system 150 and the tracking system 160 can function as a single system.

In one embodiment, each of the transaction processing applications 110, report system 150, and tracking system 160 are embodied as a single system. Therefore, the single system can internally track states of transactions and recover transactions when needed. In other embodiments, each of the transaction processing applications 110, report system 150, and tracking system 160 are separate systems and communicate with one another through a network, such as any wired or wireless local area network (LAN) and/or wide area network (WAN), such as an intranet, an extranet, or the Internet.

Generally, a transaction processing application 110 performs one or more steps of a transaction and for each performed step, the transaction processing application 110 generates a message representing the completion of the step of the transaction. Each transaction processing application may perform steps for a particular phase of a transaction (e.g., creation, validation, execution, reporting phases). The report system 150 collects the messages generated by each of the transaction processing applications 110 and converts the messages into reports. The tracking system 160 incorporates reports into an immutable master blockchain such that each step of each transaction that has been performed by a transaction processing application 110 is reflected by a report in the master blockchain. The tracking system 160 further creates lineage blockchains that are each specific for a transaction. The tracking system 160 accesses lineage blockchains to determine states of the transaction and identify transaction exceptions. Thus, the tracking system 160 can rectify a transaction exception by initiating the recovery process for the transaction.

As used herein, a transaction refers to an individual, indivisible operation that completes or fails as a single operation. A transaction can be performed in multiple steps, though if a single step in the transaction fails, then the transaction as a whole fails. As several examples, a transaction may involve reading information from a storage location in a computer system, writing information to a location, or performing processing on a unit of information. Computer systems perform transactions for a wide variety of purposes. For example, transaction processing is especially useful in computing environments for tracking the state of a large number of entities, such as managing airline reservations, executing item purchases, tracking movement and/or location of items (e.g., in a warehouse), and asset transfers. Transaction processing may also be used in computing environments such as database systems, web servers, autonomous vehicle control, etc.

Referring to FIG. 1, transaction processing applications 110 may be organized in series. Therefore, in order to fully execute a transaction, a first transaction processing application 110 provides information to perform steps of the transaction to a second transaction processing application 110 located downstream to the first transaction processing application 110. Specifically, transaction processing application 110A may perform a first set of steps for a first phase of a transaction. The transaction processing application 110A passes the output of the first set of steps of the transaction to the transaction processing application 110B, which performs a second set of steps for a second phase of the same transaction. The transaction processing application 110B passes the output of the second set of steps of the transaction to the transaction processing application 110C, which performs a third set of steps for a third phase of the transaction.

In various embodiments, each transaction processing application 110 may operate using individual processor(s) and/or other hardware, such as hardware of a computing device. In other embodiments, each transaction processing application 110 may be an individual terminal of the same system. Although three transaction processing applications 110 are illustrated in FIG. 1, in other embodiments the environment 100 may include fewer or more than three transaction processing applications 110 for performing steps of a transaction.

As shown in FIG. 1, each transaction processing application 110 includes a processing module 120 and a message queue 125. The processing module 120 receives information for performing one or more steps of a transaction, performs the one or more steps of the transaction using the received information, generates messages for the performed steps of the transaction, and stores the generated messages in the message queue 125.

In various embodiments, the processing module 120 of a transaction processing application 110 receives information for performing steps of a transaction from an external system or from an upstream transaction processing application 110. In one embodiment, referring to FIG. 1, the processing module 120A of the furthest upstream transaction processing application 110A receives information from an external system to initiate a transaction. Such information can be in the form of a transaction request that identifies one or more parties involved in the transaction as well as assets that are to be transferred between the one or more parties. Thus, the processing module 120A can perform the steps corresponding to the creation phase of the transaction.

In various embodiments, the processing module 120 (e.g., such as processing modules 120B or 120C) receives information from an upstream transaction processing application 110 that enables the processing module 120B or 120C to perform steps corresponding to subsequent phases of the transaction. An upstream transaction processing application 110 refers to a transaction processing application located earlier in the series. For example, as shown in FIG. 1, transaction processing application 110A an upstream transaction processing application relative to transaction processing application 110B and/or 110C. Information received from an upstream transaction processing application includes information such as an identifier assigned to the transaction by the upstream transaction processing application 110. Examples of an identifier assigned to the transaction are described in further detail below.

Based on the received information, the processing module 120 performs one or more steps of the transaction. For example, referring to FIG. 1, processing module 120A of transaction processing application 110A may perform a series of steps to initiate the transaction. Processing module 120B of transaction processing application 110B may perform a series of steps to execute an intermediate phase of the transaction. Processing module 120C of transaction processing application 110C may perform a series of steps to report the executed transaction.

For each step of the transaction that the processing module 120 performs, the processing module 120 generates a message corresponding to the step of the transaction, thereby reflecting the fact that the step of the transaction has been performed. In various embodiments, the generated message includes a payload that represents parameters of the transaction. Parameters of the transaction can represent the task being performed during the transaction and can include information such as the parties involved in the transaction, the amount of an asset being transferred between the parties, and the time/date that the transaction was initiated. In some embodiments, the processing module 120 includes one or more identifiers in the message. Generally, the identifiers represent identifying information of steps of the transaction. The one or more identifiers in messages facilitate the subsequent processing and tracking of the messages.

In one embodiment, the processing module 120 assigns a linkage identifier to the message. The linkage identifier serves as a value that is assigned to all messages that correspond to steps of a single transaction performed by a single processing module 120. In other words, the linkage identifier can be used to identify all messages related to a specific transaction that were processed by a processing module 120 of a particular transaction processing application 110. In various embodiments, the processing module 120 assigns an action identifier to the message. Here, the action identifier refers to a particular action of the performed step of the transaction. For example, an action identifier may be a transfer action, an awaiting authorization action, awaiting instruction action, or an authorization action. In various embodiments, the processing module 120 assigns an order identifier to the message. Here, the order identifier can be represented as a timestamp corresponding to when the step of the transaction was performed. Generally, the order identifier enables the message to be appropriately ordered in relation to other messages generated by the processing module 120. In various embodiments, the processing module 120 assigns a carry forward identifier to the message. The carry forward identifier is a value that enables compilation of messages that are related to one transaction that is performed across different transaction processing applications 110. Therefore, as a transaction is passed from a first transaction processing application 110 to a second transaction processing application 110, the messages generated by the first and second transaction processing applications as a result of performing steps of the transaction can have the same carry forward identifier. In some embodiments, a generated message can include one, two, three, or all four of the identifiers (e.g., linkage identifier, action identifier, order identifier, and carry forward identifier).

In various embodiments, transaction processing application 110A, 110B, and 110C generates a message according to a configuration specific to a transaction processing application. Therefore, messages generated by transaction processing applications 110 may have different configurations, hereafter referred to as schemas. A schema of a message refers to the organization of data values in the message. As an example, the schema of a message generated by a first transaction processing application 110 can describe that a first data value that represents a linkage identifier is located in a first column, a second data value that represents an action identifier is located in a second column, and a third data value that represents payload information is located in a third column. The schema of a message generated by a second transaction processing application 110 can describe that payload information is located in a first column, a first identifier is in a second column, and a second identifier is in a third column. Thus, different messages generated by different transaction processing applications 110 may have different schemas that are particular to a transaction processing application 110.

The processing module 120 places generated messages in a message queue 125 of the transaction processing application 110. Generally, a message queue 125 is a database that holds messages generated by transaction processing applications 110. Although FIG. 1 depicts three separate message queues 125A, 125B, 125C that are each in an individual transaction processing application 110, in some embodiments, the system environment 100 may include a single message queue 125 that queues messages from processing modules 120A, 120B, and 120C.

After the processing module 120 performs steps for a transaction, the transaction enters into a particular state. For example, a transaction state can indicate that the transaction is pending authorization, is approved, is awaiting feedback, is blocked pending availability of a resource, is settled, is completed, or is canceled. In some embodiments, a transaction exception may occur. A transaction exception can refer to a transaction error. A transaction error refers to an unexpected break in a transaction. As one example, a transaction error can occur as a transaction is passed from a first transaction processing application 110 to a second transaction processing application 110. For example, if the second transaction processing application 110 does not receive a transaction that was passed along by the first transaction processing application, then a transaction exception occurs. As another example, a transaction exception occurs while a processing module 120 is performing multiple steps of a transaction. For example, if the processing module 120 of the transaction processing application 110 has been performing a particular step of the transaction for an amount of time that is significantly more than the historical average processing time for that particular step, then a transaction exception occurs. As described in further detail below, the tracking system 160 monitors the transactions for transaction exceptions which may be due to a fault in an application, a computer system executing the application, or due to another issue.

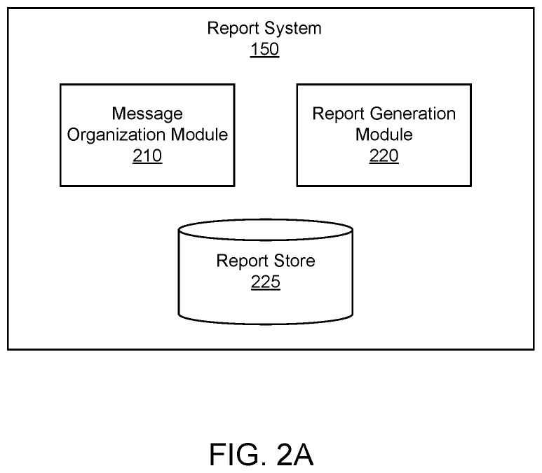

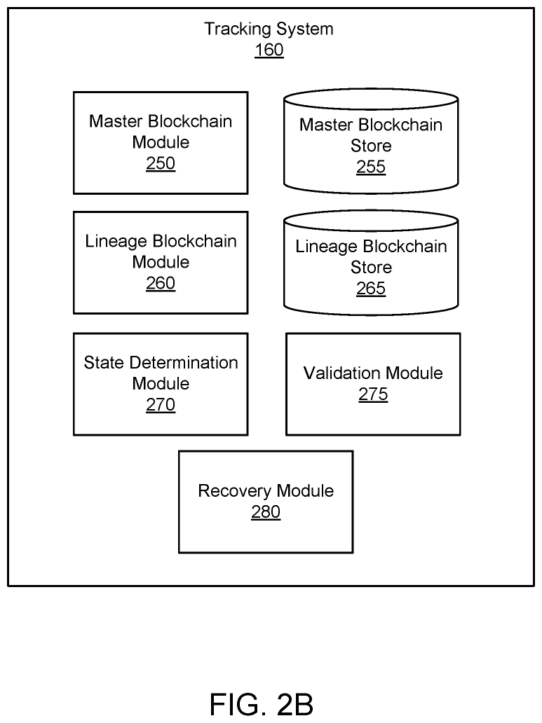

The report system 150 accesses messages from message queues 125 and generates reports for messages. FIG. 2A depicts an example block diagram of a report system 150, in accordance with an embodiment. Here, the report system 150 can include a message organization module 210 and a report generation module 220.

The message organization module 210 monitors the message queues 125 of the transaction processing applications 110, accesses newly generated messages in the message queues 125, and organizes the messages according to one or more identifiers (e.g., linkage identifier, action identifier, order identifier, or carry forward identifier) that are included in the messages. The message organization module 210 generates sets of messages, where each set includes messages that correspond to a particular transaction. Additionally, the message organization module 210 orders the messages in the set according to, for example, an order in which the steps of the transaction were performed. The message organization module 210 can then provide the sets of messages to the report generation module 220.

To generate a set of messages, the message organization module 210 parses the message queues 125 for messages that have been generated as a result of a performed step of the particular transaction. More specifically, the message organization module 210 searches the message queues 125 for messages that include a particular linkage identifier and/or a particular carry forward identifier that represent the transaction.

In various embodiments, the message organization module 210 identifies messages that correspond to a transaction through a multi-step approach. First, the message organization module 210 identifies messages generated by a single transaction processing application 110 by identifying messages that include a common linkage identifier that was assigned to messages by the transaction processing application 110. Next, the message organization module 210 identifies messages corresponding to the transaction that have been generated by other transaction processing applications 110 by using the carry forward identifier in the identified messages. The message organization module 210 uses the linkage identifier in identified messages that have been generated by other transaction processing applications 110 to identify additional messages generated by other processing applications 110.

To provide an example, referring to FIG. 1, the message organization module 210 can access a first message from message queue 125A and then parses the message queue 125A for other messages that have the same linkage identifier. Thus, the message organization module 210 can identify messages derived from steps of a transaction that have been performed by transaction processing application 110A. The message organization module 210 extracts the carry forward identifier from these identified messages generated by the transaction processing application 110A and then parses the message queues 125 (e.g., message queues 125B and 125C) of other transaction processing applications 110B and 110C to identify messages that include a matching carry forward identifier. These additional identified messages represent messages generated by the other transaction processing applications 110B and 110C that also correspond to performed steps of the same transaction.

In some embodiments, not all messages that correspond to the transaction in message queues 125B and 125C include the matching carry forward identifier. Here, the message organization module 210 can access the linkage identifier of identified messages from the message queues 125B and 125C and further parses message queues 125B and 125C for additional messages that include a matching linkage identifier. The message organization module 210 compiles the identified messages generated by transaction processing application 110A and other transaction processing applications 110B and 110C. Thus, the message organization module 210 can identify a comprehensive list of messages from the message queues 125B and 125C that correspond to the same transaction.

The message organization module 210 can further filter and organize messages in each set of messages in message queues 125A, 125B, 125C based on the action identifier in each message. The message organization module 210 can filter messages in each set according to the action identifier in each message, and therefore, can isolate messages that correspond to performed steps of the transaction that are of a particular type. For example, the message organization module 210 can isolate messages that correspond to steps of a transaction which belong to a particular transaction type. An example transaction type can be a type of the transaction processing application 110 and/or a phase of a transaction that is performed. Thus, the message organization module 210 leverages the action identifier to action specific transaction types into the individual lineage blockchains.

The message organization module 210 can further organize messages in sets of messages based on the order identifier in messages. As described above, the order identifier in a message can be represented as a timestamp corresponding to when the step of the transaction was performed. Thus, the message organization module 210 can temporally order the messages in the set based on when the corresponding steps of the transaction were performed.

Generally, the report generation module 220 generates a set of reports from the set of messages and stores the reports in the report store 225. In various embodiments, the report generation module 220 generates a report for each message. In other words, there is a 1:1 correlation between each message and each report. The report generation module 220 generates reports by converting the schema of different messages to a common schema. Put another way, the report generation module 220 normalizes the disparate schemas of messages generated by the different transaction processing applications 110 such that the generated reports have a unified, common schema that can be more efficiently processed and stored. Thus, in various embodiments, a report may include the data values that were originally included in a message; however, the organization of the data values in the report differs from the organization of the data values in the message.

In various embodiments, the report generation module 220 performs and/or ensures the organization of the generated reports. For example, the set of messages may be ordered (e.g., ordered according to the order identifiers of the messages in the set). Therefore, the report generation module 220 maintains the order of the reports in the set of reports. By doing so, the generated set of reports represent the performed steps of a transaction across multiple transaction processing applications 110.

Although the subsequent description refers to converting the schema of a single message to a common schema, the description also applies to converting the schema of messages from a set and/or messages from different sets to a common schema. Generally, to convert the schema of a message, the report generation module 220 first determines the schema of the message generated by a transaction processing application and compares the determined schema of the message to a common schema.

Briefly, the report generation module 220 may identify attributes of data values within the message to determine the types of data values within the message. Attributes of a data value can be an object type of the data value (e.g., string, Boolean, number, integer, and the like) or other patterns of the data value (e.g., a number of digits in the data value, an estimated range of values for the data value, a format of the data value, a presence of unique symbols in the data value). To identify attributes for a data value in the message, the report generation module 220 may perform a pattern recognition on the data value. As one example, the report generation module 220 identifies a regular expression (regex) from the sequence of characters in the data value. A regular expression can be any pattern in the data value such as a particular format of a linkage identifier or a carry forward identifier. Therefore, an identified regular expression can serve as the extracted attributes of a data value and is then used to define the type of data values within the message. The particular organization of the types of data values within the message defines the schema of the message.

Given the schema of the message, the report generation module 220 determines how to convert the schema of the message to a common schema. For example, the report generation module 220 can determine that certain data values in the message are to be shifted, swapped, or altered in order to change the organization of the data values in the message to meet the organization of data values in the common schema. To provide an example, a schema of a message generated by a transaction processing application 110 can be determined to be:

Schema={Payload, Linking ID, Action ID, Order ID, Carry Forward ID}

On the other hand, the common schema can be arranged as:

Common Schema={Linking ID, Action ID, Payload, Order ID, Carry Forward ID}.

In this scenario, the report generation module 220 can convert the schema of the message from the transaction processing application 110 by moving the “Payload” data value(s) into the third position and by shifting the “Linking ID” and “Action ID” into the first and second positions, respectively.

Thus, the report generation module 220 generates reports that include data values that are organized according to the common schema and stores the reports in the report store 225. The report store 225 is a database that holds the reports. The reports can be subsequently accessed from the report store 225 for storing in a blockchain, as is described in further detail below.

### Tracking System 160

The tracking system 160 tracks states of the transactions executed by the transaction processing applications 110, validates reports of transactions within a blockchain, and recovers transactions that have experienced transaction exceptions. More specifically, the tracking system 160 maintains a master blockchain that includes blocks of reports representing steps of various transactions performed by the transaction processing applications 110. Furthermore, the tracking system 160 maintains separate lineage blockchains that each include blocks of reports that represent performed steps of an individual transaction. The tracking system 160 can identify transaction exceptions by monitoring reports within lineage blockchains. The tracking system 160 can further verify that a transaction has not been inappropriately altered (e.g., hacked) by validating the block hash values of the lineage blockchain for the transaction and/or the master blockchain. Once the transaction is validated, the tracking system 160 can trigger a recovery process to address the transaction exception.

FIG. 2B depicts an example block diagram of a tracking system 160, in accordance with an embodiment. As shown in FIG. 2B, the tracking system 160 includes a master blockchain module 250, a lineage blockchain module 260, a state determination module 270, a validation module 275, a recovery module 280, a master blockchain store 255, and a lineage blockchain store 265. In other embodiments, the tracking system 160 can include additional or fewer modules or stores. For example, in some embodiments, the tracking system 160 need not include the lineage blockchain store 265 for storing lineage blockchains.

The master blockchain module 250 accesses reports stored in the report store 225 of the report system 150, and writes reports to blocks in a master blockchain. Generally, the master blockchain module 250 accesses reports irrespective of the transaction to which the reports correspond. In other words, the master blockchain includes reports corresponding to all transactions executed by the transaction processing applications 110. The master blockchain module 250 stores the master blockchain in the master blockchain store 255.

In various embodiments, the master blockchain module 250 generates a block of reports based on a particular time period (e.g., a block includes reports that were generated within a span of N minutes). For example, the master blockchain module 250 accesses reports that were stored in the report store 225 within a time period and generates a first block in the master blockchain that includes the reports. Next, the master blockchain module 250 accesses additional reports that were stored in the report store 225 within a next time period and generates a second block that includes the additional reports. The second block is written adjacent to the first block in the master blockchain.

In various embodiments, the master blockchain module 250 generates blocks of reports based on a number of reports (e.g., a block is generated for every N reports). As an example, the master blockchain module 250 accesses a first N reports and generates the first block in the blockchain that includes the first N reports. Next, the master blockchain module 250 accesses the next N reports and generates the next, adjacent block in the blockchain that includes the next N reports. The master blockchain module 250 continues to repeat this process for subsequent reports to build the master blockchain.

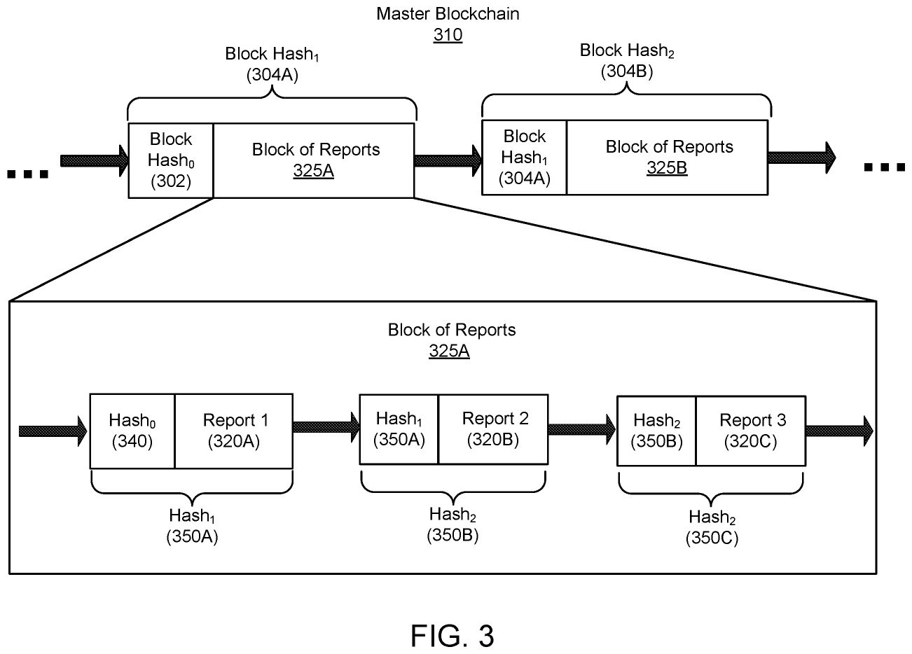

Reference is now made to FIG. 3, which depicts an example master blockchain 310 that includes blocks of reports 325, in accordance with an embodiment. The master blockchain 310 includes multiple blocks of reports 325 that are immutably linked. In various embodiments, a block of reports includes a block hash (e.g., a hash value) of the prior block in the master blockchain, thereby ensuring the immutability of the master blockchain.

To generate immutably linked blocks of reports, the master blockchain module 250 combines a block of reports with a header. The header includes a hash that represents the immediately preceding block. The master blockchain module 250 performs a hash of the combined header and block of reports. In various embodiments, the master blockchain module 250 performs one of a message digest algorithm 5 (MD5), a secure hash algorithm (SHA) (e.g., SHA-0, SHA-1, SHA-2, or SHA-3), BLAKE, or other hash functions of the like. The master blockchain module 250 includes the hash of the combined header and block as a subsequent header. The master blockchain module 250 can repeat this process to continue to build the master blockchain 310.

Referring specifically to FIG. 3, the master blockchain module 250 combines block of reports 325A with a header that is represented by a block hash value (e.g., block hash₀ 302). The master blockchain module 250 generates a block hash₁ 304A by hashing the combined block hash₀ 302 and block of reports 325A. The master blockchain module 250 includes the generated block hash₁ 304A in a subsequent header and combines the block hash₁ 304A with the subsequent block of reports 325B. The master blockchain module 250 generates block hash₂ 304B by hashing the combined block hash₁ 304A and block of reports 325B and continues to process to build the master blockchain 310.

In various embodiments, a block of reports 325 includes reports that are additionally immutably linked. The master blockchain module 250 can combine a report with a hash value that represents the immediately preceding report. The master blockchain module 250 can generate a hash value of the combined report and hash value. The master blockchain module 250 then combines the generated hash value with the next report and repeats this process for the next report to continue to build a block of reports. By immutably linking individual reports within a block of reports 325, the master blockchain module 250 can leverage the immutability of the master blockchain and detect erroneous or malicious activity at the level of individual reports.

Referring specifically to FIG. 3, report 1 (320A) is combined with a header that is represented by a hash value (e.g., hash₀ 340). For example, report 1 (320A) is appended to hash₀ 340. The master blockchain module 250 performs a hash of the hash₀ 340 and report 1 (320A) to generate hash₁ 350A. The master blockchain module 250 appends a subsequent report (e.g., report 2 (320B)) to the hash of the prior report (e.g., hash₁ 350A). The master blockchain module 250 generates hash₂ (350B) by hashing the combination of hash₁ 350A and report 2 (320B). The master blockchain module 250 repeats the process for report 3 (320C).

In various embodiments, the master blockchain module 250 includes reports 320 in a block of reports 325 and need not immutably link the reports 320 in a blockchain. For example, referring to FIG. 3, a block of reports 325A can include report 1 (320A), report 2 (320B), and report 3 (320C) without the corresponding hashes (e.g., hash₀ (340), hash₁ (350A), hash₂ (350B), and hash₃ (350C)). Thus, in these embodiments, the master blockchain 310 can include blocks of reports 325 that are immutably linked through block hash values, but the individual reports 320 of blocks 325 need not be immutably linked.

Returning to FIG. 2B, the master blockchain store 255 holds the master blockchain 310. Given that the master blockchain 310 includes blocks of reports that correspond to all transactions executed by the transaction processing applications 110, the master blockchain store 255 holds one copy of the master blockchain 310. The master blockchain store 255 persistently holds the master blockchain 310 so that the immutably linked blocks of reports are available for access when needed.

The lineage blockchain module 260 generates lineage blockchains that are specific for a transaction. Given that a lineage blockchain corresponds to the sequence of steps comprising a specific transaction, the reports included in the lineage blockchain enable the tracking of the state of the transaction. Generally, the blocks of the lineage blockchain are immutably linked to ensure the validity of the reports of the lineage blockchain. The implementation of lineage blockchains is advantageous as the tracking system 160 can quickly determine states of different transactions, and recover from any errors, by accessing the lineage blockchains as opposed to having to access and parse reports of different transactions in the master blockchain.

In various embodiments, to generate a block of reports in a lineage blockchain, the lineage blockchain module 260 accesses sets of reports that correspond to a particular transaction. As one example, the lineage blockchain module 260 identifies the appropriate set of reports to be assembled into a lineage blockchain by matching the linkage identifier or carry forward identifier included in reports to a corresponding linkage identifier or carry forward identifier included in reports of particular locations in the master Blockchain corresponding to the steps of the particular transaction.

In various embodiments, the lineage blockchain module 260 identifies reports that are to be included in a block of a lineage blockchain by parsing reports included in the master blockchain for reports that are specific for a transaction. In various embodiments, the lineage blockchain module 260 identifies reports in the master blockchain 310 that are specific for a particular transaction based on an identifier, such as the linkage identifier and/or carry forward identifier, included in the reports. In various embodiments, the lineage blockchain module 260 begins at the genesis block of the master blockchain 310 and proceeds along the master blockchain 310 to identify reports in the master blockchain 310 that include a particular linkage identifier and/or a carry forward identifier.

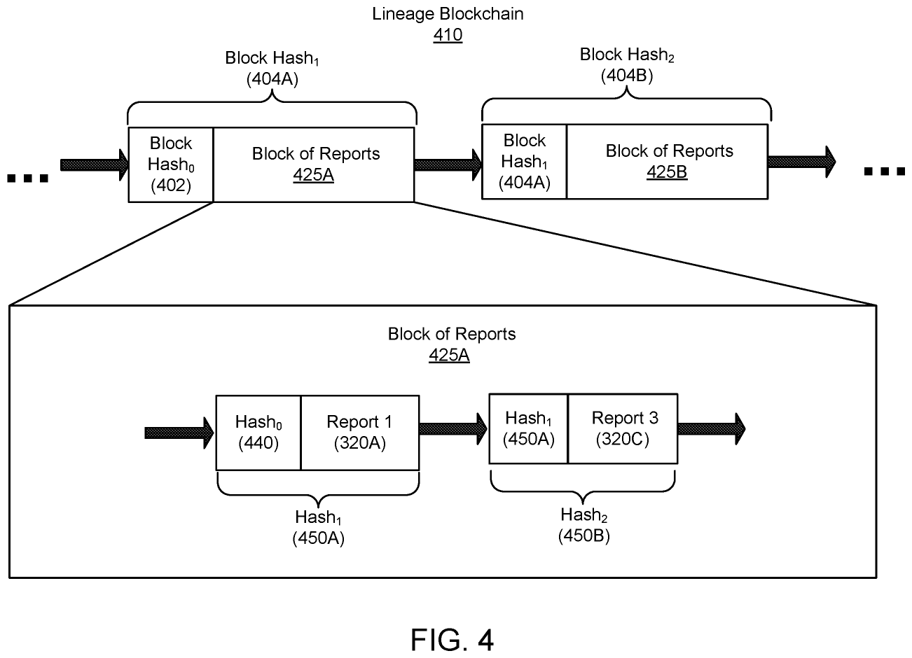

Reference is now made to FIG. 4, which depicts an example lineage blockchain 410 that includes blocks of reports 425 that are specific for a transaction, in accordance with an embodiment. The lineage blockchain 410 includes multiple blocks of reports 425 that are immutably linked. In various embodiments, a block in the lineage blockchain 410 includes a block hash (e.g., a hash value) of the prior block in the lineage blockchain 410, thereby ensuring the immutability of the lineage blockchain 410.

The lineage blockchain 410 shown in FIG. 4 differs from the master blockchain 310 shown in FIG. 3 in that the lineage blockchain 410 includes a subset of reports included in the master blockchain 410 organized into the order corresponding to the steps of a specific transaction. Here, the ordered subset of reports corresponds to a transaction. For example, assume that report 1 (320A) and report 3 (320C) that were included in the master blockchain 310 (see FIG. 3) are reports that correspond to a particular transaction whereas report 2 (320B) corresponds to a different transaction. Thus, the lineage blockchain module 260 includes report 1 (320A) and report 3 (320C) within a block of reports 425A of the lineage blockchain 410 (see FIG. 4) that is specific for the same transaction but does not include report 2 (320B) in the lineage blockchain 410.

The lineage blockchain module 260 may generate immutably linked blocks of reports in the lineage blockchain 410 using methods described above in relation to the master blockchain module 250 for generating the master blockchain 310. For example, the lineage blockchain module 260 performs hashes (e.g., one of a MD5, SHA or other hash function) of the header and block of reports 425 and includes the hash as a header of a subsequent block to immutably link the blocks. Additionally, the lineage blockchain module 260 can similarly generate blocks based on a particular time (e.g., e.g., a block includes reports of a particular transaction that were generated within a span of N minutes) or based on a number of reports (e.g., a block is generated for every N reports of a particular transaction).

In various embodiments, the lineage blockchain module 260 orders the reports in each block of the lineage blockchain. For example, the lineage blockchain module 260 uses the time that the reports were generated to order the reports of the lineage blockchain to correspond to the steps of the transaction. Therefore, the reports in each block of the lineage blockchain are chronologically organized. As another example, the lineage blockchain module 260 categorizes the reports by the entity or the system that has processed the transaction and orders the reports according to the categories. Therefore, a first set of reports in a block of the lineage blockchain can correspond to steps of a transaction performed by a first entity, which is subsequently followed by a second set of reports in the block of the lineage blockchain that correspond to steps of the transaction performed by a second entity. The resulting lineage blockchain can thus be used to identify the point in the sequence of steps in the transaction at which the exception has occurred and can serve as a means of initiating a recovery process, ultimately assisting in completion of the transaction.

In various embodiments, the lineage blockchain module 260 generates blocks of reports 425 that includes reports that are also immutably linked. For example, referring to FIG. 4, the lineage blockchain module 260 can combine report 1 (320A) with a header that is represented by a hash value (e.g., hash₀ 440). The lineage blockchain module 260 performs a hash of the hash₀ 440 and report 1 (320A) to generate hash₁ 450A. The lineage blockchain module 260 appends the subsequent report (e.g., report 3 (320C)) to the hash of the prior report (e.g., hash₁ 450A). The lineage blockchain module 260 generates hash₂ (450B) by hashing the combination of hash₁ 450A and report 3 (320C). Thus, the lineage blockchain module 260 generates a block of reports 425A that includes reports that are immutably linked in the sequential order in which they were generated.

In various embodiments, the lineage blockchain module 260 need not immutably link the reports 320A and 320C in a block of reports 425 of the lineage blockchain 410. For example, referring to FIG. 4, a block of reports 425A can include report 1 (320A) and report 3 (320C) without the corresponding hashes (e.g., hash₀ (440), hash₁ (450A), and hash₂ (450B)). Thus, in these embodiments, the lineage blockchain 410 can include blocks of reports 425 that are immutably linked through block hash values, but the individual reports 320A and 320C of the block of reports 425 need not be immutably linked.

The lineage blockchain store 265 holds lineage blockchains 410 generated by the lineage blockchain module 260. In various embodiments, as the transaction processing applications 110 execute transactions, the lineage blockchain store 265 holds lineage blockchains 410 corresponding to the currently executing transactions. In various embodiments, the lineage blockchain store 265 can remove a lineage blockchain 410 that need not be persistently stored in memory. For example, once a transaction completes, the lineage blockchain 410 for the transaction can be removed. In an embodiment, the lineage blockchain store 265 removes a lineage blockchain 410 from memory after a threshold amount of time. In other words, a lineage blockchain 410 can expire and be removed from the lineage blockchain store 265 after passage of the threshold amount of time. The threshold amount of time may be dependent on (e.g., measured from) when the transaction enters into a state that indicates that the transaction has completed.

The state determination module 270 periodically checks for states of transactions and determines whether a transaction is in a state that indicates that a transaction exception has occurred. The state determination module 270 determines the state of a transaction by accessing a lineage blockchain specific for the transaction. In various embodiments, the state determination module 270 investigates the reports in the final block in the lineage blockchain. Specifically, the state determination module 270 can access the final report (e.g., final report based on the order identifier included in the report) in the final block in the lineage blockchain and determine whether the final report indicates that the transaction is in a terminated state. A terminated state indicates that the transaction has been completed. Examples of a terminated state for a transaction can include a “settled” state or a “cancelled” state. If the state determination module 270 determines that the final report indicates that the transaction is in a terminated state, then the transaction can be deemed complete.

If the state determination module 270 determines that the final report indicates a mid-processing state and does not indicate an expected terminated state, the state determination module 270 determines whether a transaction exception has occurred by querying the order identifier in the final report. Specifically, the state determination module 270 compares the order identifier in the final report, which represents a timestamp when the last step of the transaction was performed, to a current time to determine whether greater than a threshold amount of time has passed since the last step of the transaction was performed. In one embodiment, the threshold amount of time is a historical average processing time (e.g., average across prior transactions) for the last step. In some embodiments, the threshold amount of time is a fixed value, such as 60 seconds, 5 minutes, 10 minutes, 1 hour, and the like.

When the state determination module 270 determines that greater than a threshold amount of time has passed since the performance of the last step of the transaction, the state determination module 270 determines that the transaction has been stopped in mid-processing and therefore, a transaction exception has occurred. The state determination module 270 can provide the current state of the transaction to the recovery module 280.

In various embodiments, the state determination module 270 can predict upcoming problems based on the detected transaction exceptions. Therefore, the state determination module 270 can notify the recovery module 280 to initiate recovery processes before the transaction exceptions develop into more severe and widespread problems. For example, the state determination module 270 can determine that above a threshold number of transactions, whose steps are being performed by a specific transaction processing application 110, are experiencing transaction exceptions. Thus, the state determination module 270 can determine that the specific transaction processing application 110 may be experiencing an outage. The state determination module 270 can provide a notification to the recovery module 280 to initiate the recovery process for the transactions and to ensure that additional transactions being processed by the specific transaction processing application 110 do not experience transaction exceptions.

In various embodiments, the state determination module 270 checks for states of transactions by periodically accessing lineage blockchains to continually ensure that transactions are being appropriately processed. For example, the state determination module 270 may check lineage blockchains every X seconds, minutes, or hours to ensure that transaction exceptions have not occurred.

The validation module 275 performs a validation process to ensure that the determined state of the transaction is valid. By validating the transaction, the validation module 275 ensures that the transaction exception that has occurred did not arise due to an inappropriate tampering of the transaction. The validation module 275 accesses the lineage blockchain for the transaction and investigates the block hash values to ensure that the reports included in the lineage blockchain specific for the transaction have not been altered. For example, the validation module 275 accesses the block hash value representing the genesis block of the lineage blockchain, then checks that the block hash value matches the block hash included in the header of the subsequent adjacent block of the lineage blockchain. The validation module 275 can repeat this process for subsequent block hash values in the lineage and so on. If the validation module 275 identifies that any of the block hash values do not align with a hash value in a header of a subsequent block, the validation module 275 can deem the transaction as invalid. Appropriate action can be taken to remove the invalid transaction. Alternatively, if the validation module 275 successfully matches each block hash value to a hash value in a header of a subsequent block, the validation module 275 can deem the transaction to be valid and can provide the determined state of the transaction to the recovery module 280 to initiate the recovery process.

In various embodiments, when the validation module 275 determines that a transaction exception has occurred for a transaction, the validation module 275 can determine how the transaction exception affects the parties involved in the transaction. The validation module 275 may determine how the parties are affected while performing the validation of the transaction. For example, as the validation module 275 sequentially validates each block hash value of each block in the lineage blockchain, the validation module 275 can track how the parties involved in the transaction are affected based on the reports in each block. In some embodiments, the determined effects of the transaction exception on the parties can be presented to the parties for remedial or informative purposes.

The recovery module 280 can generate an alert that identifies the transaction exception, logs the alert, and can further initiate a recovery process to address the transaction exception. In one embodiment, the recovery module 280 sends a request to the transaction processing application 110 where the transaction exception has occurred to continue the remaining steps of the transaction. Here, the request can include one or more identifiers that enable the transaction processing application 110 to identify the step of the transaction during which the transaction exception has occurred. For example, the request can include the linkage identifier and the action identifier included in the report.

In some embodiments, the recovery module 280 can initiate a recovery process through alternative systems to ensure that the alternative systems can resolve the transaction exception by performing the remaining steps of the transaction. This may be beneficial in scenarios where the transaction exception arose because of an unexpected malfunction of the transaction processing application 110 (e.g., the transaction processing application 110 is experiencing an outage). Alternative systems may be third party systems not affiliated with the tracking system 160.

In some embodiments, the initiation of a recovery process for a transaction further involves the recovery module 280 providing the lineage blockchain specific for the transaction to the transaction processing application 110 or to the alternative system. Thus, the transaction processing application 110 or the alternative system can use the lineage blockchain to further establish the validity of the transaction.

In some embodiments, the recovery module 280 can initiate a recovery process that requires input from one or more users. For example, each of one or more users can provide approval at various stages of the remaining steps of the transaction. Requiring input from multiple users can ensure the validity of the recovery process as the remaining steps of the transaction are performed.

The recovery module 280 can notify the state determination module 270 of the recovery process for a particular transaction. Therefore, the state determination module 270 can periodically check the lineage blockchain of the particular transaction to determine whether an updated state of the transaction indicates that the transaction has been recovered and/or completed.

### Process for Managing Transaction States

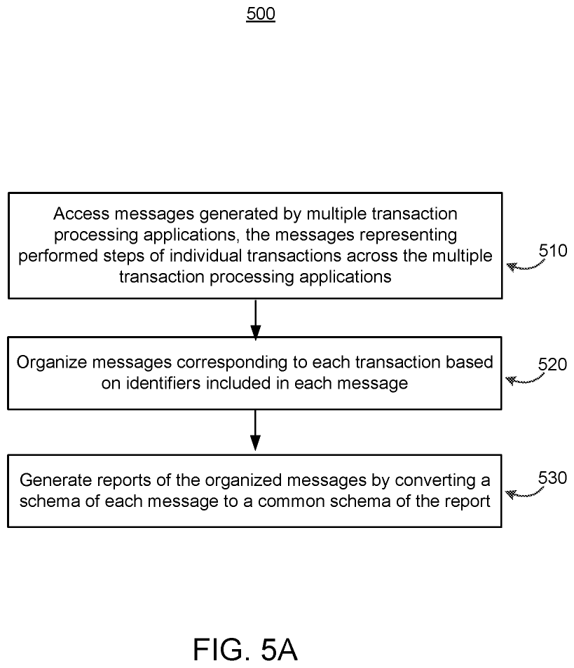

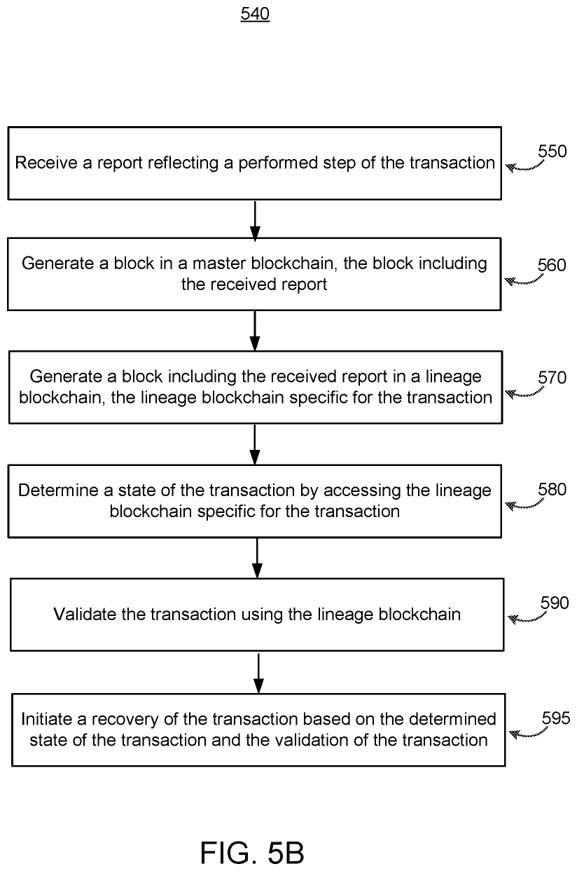

FIG. 5A depicts a flow process 500 for generating reports of performed steps of transactions, in accordance with an embodiment. The report system 150 accesses 510 messages generated by multiple transaction processing applications 110. Here, each message represents a step of a transaction performed by a transaction processing application 110. The report system 150 organizes 520 messages that each correspond to a particular transaction, based on the identifiers included in the messages. In one embodiment, the report system 150 identifies messages that correspond to a particular system based on the linkage identifier and/or the carry forward identifier included in each message. In one embodiment, the report system 150 organizes messages based on the action identifier and/or the order identifier included in each message. Altogether, the report system 150 organizes a set of messages that is particular for a single transaction performed across multiple transaction processing applications. The report system 150 generates 530 reports of the organized set of messages. More specifically, for each message in the organized set, the report system 150 determines a schema of the message and converts the schema of the message to a common schema. Here, the report system 150 ensures that information in the reports, which are derived from messages accessed from varying transaction processing applications, are consistently organized such that the reports can be effectively stored, e.g., in a blockchain.

FIG. 5B depicts a flow process 540 for managing states of transactions using immutable lineages, in accordance with an embodiment. The tracking system 160 receives 550 a report representing a performed step of the transaction. The tracking system 160 generates 560 a block that includes the received report in a master blockchain. Here, the blocks of reports in the master blockchain include reports that correspond to performed steps of different transactions. The blocks of reports in the master blockchain are immutably linked through block hash values.

The tracking system 160 generates 570 a block of reports including the received report in a lineage blockchain. The lineage blockchain is specific for the transaction and only includes reports that correspond to the performed steps in the transaction, in the order of their creation.

The tracking system 160 determines 580 a state of the transaction by accessing the lineage blockchain specific for the transaction. For example, the tracking system 160 accesses the reports in the final block of the lineage blockchain to determine whether the transaction is currently in a mid-processing state or if the transaction has completed and is in an expected termination state. If the transaction has been in a mid-processing state for an extended amount of time, the tracking system 160 may validate 590 the transaction using the lineage blockchain. Specifically, the tracking system 160 validates the block hash values of the lineage blockchain. The tracking system 160 initiates 595 a recovery of the transaction based on the determined state of the transaction and the validation of the transaction. The tracking system 160 can provide a request that includes the determined state of the transaction to a transaction processing application 110 to continue processing the transaction. Thus, the tracking system 160 ensures that the transaction can be completed as intended.

### Example Computing Device

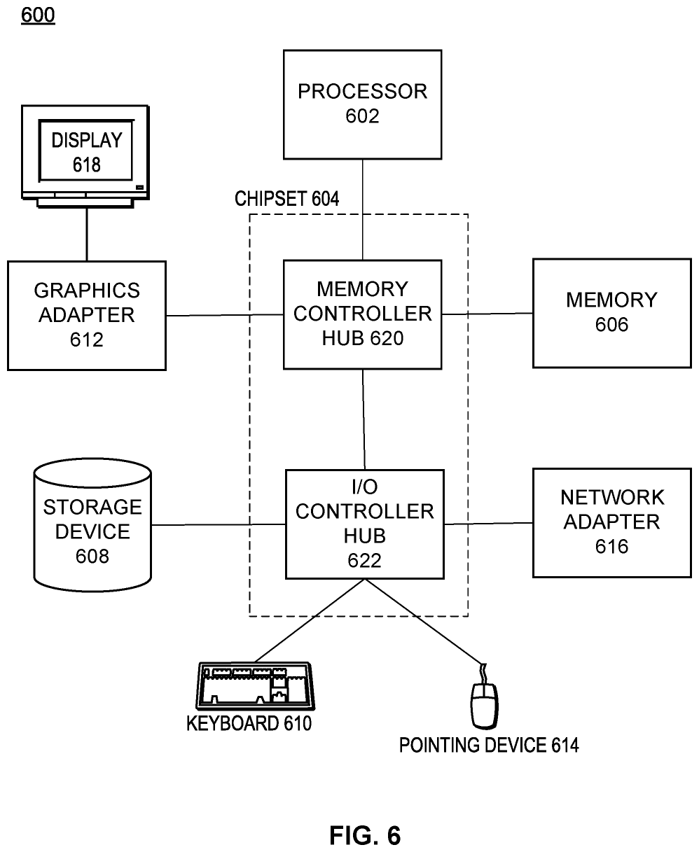

FIG. 6 is a high-level block diagram illustrating physical components of a computer 600 used as part or all of one or more of the entities described herein in one embodiment. For example, instances of the illustrated computer 600 may be a computing device that operates a transaction processing application 110 or a computing device that operates a report system 150 and tracking system 160. Illustrated are at least one processor 602 coupled to a chipset 604. Also coupled to the chipset 604 are a memory 606, a storage device 608, a keyboard 610, a graphics adapter 612, a pointing device 614, and a network adapter 616. A display 618 is coupled to the graphics adapter 612. In one embodiment, the functionality of the chipset 604 is provided by a memory controller hub 620 and an I/O hub 622. In another embodiment, the memory 606 is coupled directly to the processor 602 instead of the chipset 604.

The storage device 608 is any non-transitory computer-readable storage medium, such as a hard drive, compact disk read-only memory (CD-ROM), DVD, or a solid-state memory device. The memory 606 holds instructions and data used by the processor 602. The pointing device 614 may be a mouse, track ball, or other type of pointing device, and is used in combination with the keyboard 610 to input data into the computer 600. The graphics adapter 612 displays images and other information on the display 618. The network adapter 616 couples the computer 600 to a local or wide area network.

As is known in the art, a computer 600 can have different and/or other components than those shown in FIG. 6. In addition, the computer 600 can lack certain illustrated components. In one embodiment, a computer 600 acting as a server may lack a keyboard 610, pointing device 614, graphics adapter 612, and/or display 618. Moreover, the storage device 608 can be local and/or remote from the computer 600 (such as embodied within a storage area network (SAN)).

As is known in the art, the computer 600 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 608, loaded into the memory 606, and executed by the processor 602.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
receiving a report representing a performed step of a transaction performed across multiple transaction processing applications;
generating a first block of reports in a master blockchain, the first block of reports including the received report, the master blockchain further including at least one report representing a performed step of a different transaction;
parsing the master blockchain to obtain reports that are associated with the specific transaction, the obtained reports including the received report;
organizing the obtained reports from the transaction into an order in which the reports were created, the order corresponding to an order of steps in the transaction;
generating a lineage blockchain specific for the transaction, the lineage blockchain storing the reports in the organized order;
determining a state of the transaction performed across the multiple transaction processing applications by querying the lineage blockchain specific for the transaction and accessing a final report in the lineage blockchain specific to the transaction;
determining that the final report in the lineage blockchain specific to the transaction indicates a mid-processing state of the transaction;
sending a request to one or more of the transaction processing applications to continue remaining steps of the transaction;
subsequently to sending the request to one or more of the transaction processing applications, determining an updated state of the transaction by accessing a new final report in the lineage blockchain specific for the transaction; and
responsive to determining that the updated state of the transaction represents a termination state of the transaction, removing the lineage blockchain from memory.

2. (canceled)

3. The method of claim 1, wherein organizing reports that are specific for the transaction is further based on entities that processed steps of the transaction that correspond to the reports.

4. (canceled)

5. The method of claim 1, wherein determining that the final report in the lineage blockchain specific to the transaction indicates a mid-processing state of the transaction comprises determination that the final block of reports does not include the report representing the termination state.

6. The method of claim 5, further comprising:
responsive to determining that the report in the final block of reports does not represent a termination state, validating the transaction using the lineage blockchain.

7. The method of claim 6, wherein validating the transaction using the lineage blockchain comprises validating hash values of blocks in the lineage blockchain to ensure validity of reports in the lineage blockchain.

8. The method of claim 1, wherein a request to continue the remaining steps of the transaction identifies the determined state of the transaction.

9. (canceled)

10. A non-transitory computer readable storage medium storing computer program instructions that, when executed by a processor, cause the processor to:
receive a report representing a performed step of a transaction performed across multiple transaction processing applications;
generate a first block of reports in a master blockchain, the first block of reports including the received report, the master blockchain further including at least one report representing a performed step of a different transaction;
parse the master blockchain to obtain reports that are associated with the specific transaction, the obtained reports including the received report;
organize the obtained reports from the transaction into an order in which the reports were created, the order corresponding to an order of steps in the transaction;
generate a lineage blockchain specific for the transaction, the lineage blockchain storing the reports in the organized order;
determine a state of the transaction performed across the multiple transaction processing applications by querying the lineage blockchain specific for the transaction and access a final report in the lineage blockchain specific to the transaction;
determine that the final report in the lineage blockchain specific to the transaction indicates a mid-processing state of the transaction;
send a request to one or more of the transaction processing applications to continue remaining steps of the transaction;
subsequently to sending the request to one or more of the transaction processing applications, determine an updated state of the transaction by accessing a new final report in the lineage blockchain specific for the transaction; and
responsive to determining that the updated state of the transaction represents a termination state of the transaction, remove the lineage blockchain from memory.

11. (canceled)

12. (canceled)

13. The non-transitory computer readable medium of claim 12, wherein the instructions that cause the processor to determine that the final report in the lineage blockchain specific to the transaction indicates a mid-processing state of the transaction comprises instructions that cause the processor to determine that the final block of reports does not include the report representing the termination state.

14. The non-transitory computer readable medium of claim 10, further comprising instructions that, when executed by the processor, cause the processor to:
responsive to the determination that the report in the final block of reports does not represent a termination state, validate the transaction using the lineage blockchain.

15. The non-transitory computer readable medium of claim 14, wherein the instructions that cause the processor to validate the transaction using the lineage blockchain further comprises instructions that, when executed by the processor, cause the processor to validate hash values of blocks in the lineage blockchain to ensure validity of reports in the lineage blockchain.

16. The non-transitory computer readable medium of claim 10, wherein a request to continue the remaining steps of the transaction identifies the determined state of the transaction.

17. (canceled)

18. A method comprising:
receiving a report representing a performed step of a transaction;
generating a first block of reports in a master blockchain, the first block of reports including the received report;
generating a second block of reports in a lineage blockchain specific for the transaction, the second block of reports including the received report;
determining a state of the transaction by querying the lineage blockchain specific for the transaction; and
initiating a recovery of the transaction based on the determined state of the transaction.

19. The method of claim 18, wherein generating the second block of reports in the lineage blockchain specific for the transaction comprises:
parsing the master blockchain for reports that are specific for the transaction; and
organizing reports that are specific for the transaction based on an order in which the reports were created that corresponds to an order of steps in the transaction.

20. The method of claim 18, wherein determining the state of the transaction by querying the lineage blockchain specific for the transaction comprises:
accessing a final block of reports in the lineage blockchain; and
determining whether a report in the final block of reports represents a termination state that indicates that the transaction is completed,
wherein initiating the recovery of the transaction is performed subsequent to the determination that the final block of reports does not include the report representing the termination state.
